(19) United States
(12) Patent Application Publication
(10) Pub. No.: US 2026/0039546 A1
(43) Pub. Date: Feb. 5, 2026

(54) INTERWORKING OF COMMUNICATION MODELS BETWEEN NETWORK FUNCTIONS

(71) Applicant: DISH Wireless L.L.C., Englewood, CO (US)

(72) Inventors: Abhishek Jayprakash Shirke, Aurora, CO (US); Dawood Shahdad, Aurora, CO (US); Prakash Patel, Castle Rock, CO (US)

(21) Appl. No.: 18/793,634

(22) Filed: Aug. 2, 2024

(51) Int. Cl. H04L 41/0816; H04L 67/56

(52) U.S. Cl. CPC H04L 41/0816; H04L 67/56

(57) ABSTRACT

Technologies for dynamic switching of network function (NF) communication models in a cellular network are described. One method include receiving, by a first NF, from a service communication proxy (SCP), a first message during the first NF running in an indirect communication model, wherein the first message indicates a failure of the SCP, and wherein, in the indirect communication model, the first NF and a second NF of a set of second NFs communicate through the SCP; responsive to receiving the first message, switching, by the first NF, from running in the indirect communication model to running in a direct communication model, wherein, in the direct communication model, the first NF and the second NF of the set of second NFs communicate without the SCP; and running the first NF in the direct communication model.

### BACKGROUND

Cellular networks are highly complex. One type of cellular network is a fifth generation (5G) new radio (NR) cellular networks. 5G NR cellular networks have the promise to provide higher throughput, lower latency, and higher availability compared with previous global wireless standards. However, some communication models in a 5G NR cellular network cannot be changed dynamically, which may compromise such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing dynamic switching of network function (NF) communication models in a cellular network according to at least one embodiment.

FIGS. 2 and 3 are block diagrams of example systems that implement dynamic switching of NF communication models in a cellular network according to at least one embodiment.

FIGS. 4A and 4B illustrate example NF communication models used in dynamic switching of NF communication models in a cellular network according to at least one embodiment.

FIGS. 5A and 5B illustrate example switching of NF communication models in a cellular network according to at least one embodiment.

FIGS. 6A and 6B illustrate example of communication in NF communication models before and after dynamic switching.

FIGS. 7, 8 and 9 are flow diagrams of example methods of dynamic switching of NF communication models in a cellular network according to at least one embodiment.

FIGS. 10A-10E illustrate examples of configuration profile for switching from running in the indirect communication model to running in the direct communication model according to at least one embodiment.

### DETAILED DESCRIPTION

Technologies for dynamic switching of network function (NF) communication models in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Conventionally, some communication models in a cellular network are either configured statically or switched manually, which may result in failure or partial shut-off of the cellular network.

Aspects and embodiments of the present disclosure address the above and other deficiencies by providing a system that implements dynamic switching of network function (NF) communication models in a cellular network. The network functions (NFs) may refer to individual services that can discover each other, utilize the services provided by each other, and interact with each other to fulfill the tasks of the cellular network. A NF (referred to as “consumer NF”) can request services from another NF (referred to as “producer NF”). The consumer NFs and the producer NFs can communicate directly in a direct communication model or indirectly in an indirect communication model. The NF may dynamically switch between a direct communication model and an indirect communication model to communicate with the producer NF. The direct communication model refers to a model, for communication between NFs, in which the consumer NF and the producer NF can communicate directly without proxy. The indirect communication model refers to a model, for communication between NFs, in which some operations related to discovery and/or selection of the NFs are delegated to a proxy, e.g., service communication proxy (SCP). The SCP may be a default outbound proxy to NFs or as a router model configured as http2 outbound proxy at each NF in cloud native environments and perform load balancing and load distribution of signaling traffic between different NF instances (or NF services).

Specifically, while the consumer NF runs in an indirect communication model, a component of the consumer NF (e.g., NF communication model switch) may receive a message from SCP indicating a failure of SCP (referred to as “SCP failure message”). Upon receiving the SCP failure message, the component of the consumer NF may switch from running in the indirect communication model to running in the direct communication model, by modifying a configuration setting in the consumer NF to disable the indirect communication model and enable the direct communication model. For example, the consumer NF may have a configuration profile that include configuration file of each communication model. In some implementations, each communication model may be enabled or disabled by a respective flag bit. In some implementations, bits may be used to store a value to indicate a respective communication model being enabled. Upon modifying the configuration setting, the consumer NF may run in the direct communication model, which does not use SCP. In some implementations, in the direct communication model, the consumer NF communicates with a network repository function (NRF) for discovery of the set of producer NFs, and the consumer NF selects the producer NF from the set of producer NFs such that the consumer NF can communicate with the selected producer NF directly. After switching from running in the indirect communication model to running in the direct communication model, the component of the consumer NF may monitor the status of SCP. For example, to monitor the status of SCP, the component of the consumer NF may send a dummy signal to SCP, and when receiving a SCP failure message or no response, the component of the consumer NF may do nothing such that the consumer NF continues running in the direct communication model. When receiving a message from SCP that indicates a recovery of SCP, the component of the consumer NF may switch back from running in the direct communication model to running in the indirect communication model such that the SCP will be used again. To switch back, the component of the consumer NF may modify the configuration setting in the consumer NF to enable the indirect communication model and disable the direct communication, similarly as described above. Upon modifying the configuration setting, the consumer NF may run in the indirect communication model, which uses SCP. In some implementations, in the indirect communication model, the SCP communicates with a network repository function (NRF) for discovery of the set of producer NFs, and the SCP selects the producer NF from the set of producer NFs such that the consumer NF can communicate with the selected producer NF via the SCP. In some implementations, in the indirect communication model, the consumer NF communicates with a network repository function (NRF) for discovery of the set of producer NFs, and the consumer NF selects the producer NF from the set of producer NFs such that the consumer NF can communicate with the selected producer NF via the SCP. As such, the component of the consumer NF may dynamically switch consumer NF between a direct communication model and an indirect communication model to communicate with the selected producer NF, for example, according to the status of the SCP.

Aspects and embodiments of the present disclosure can use monitoring and the real-time measurement context of the cellular network for automatic and dynamic switch the communication model for the communication between NFs in the cellular network. Aspects and embodiments of the present disclosure can improve system performance and cost-efficiency by providing suitable NF communication models.

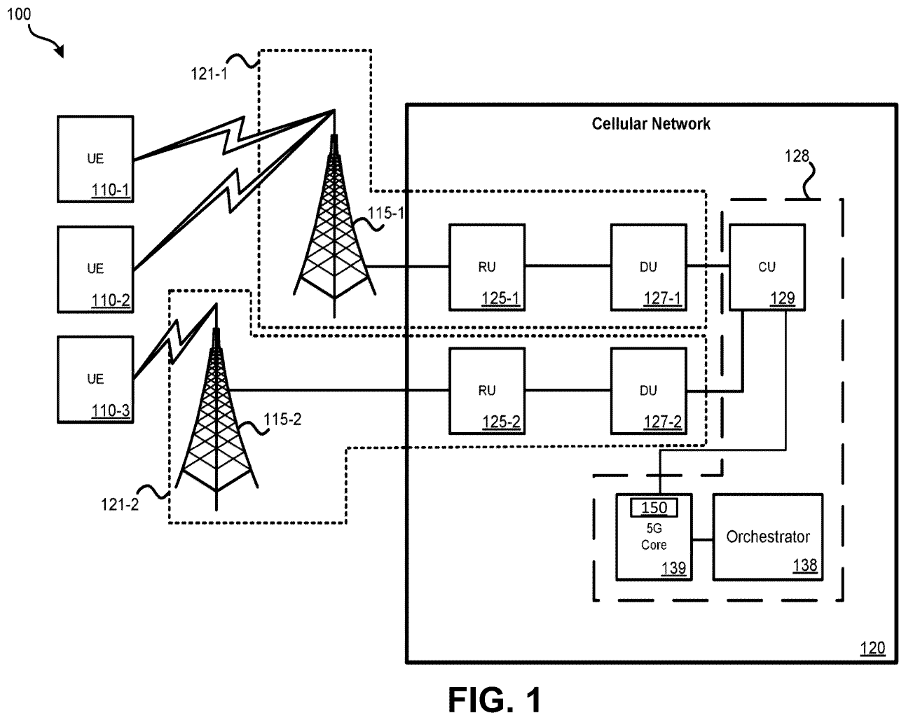

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) (e.g., NRF 251) and network slice selection function (NSSF) (e.g., NSSF 338). NRF can allow 5G network functions (NFs) to register and discover each other via a standards-based application programming interface (API). NSSF can be used by access and mobility management function (AMF) (e.g., AMF 334) to assist with the selection of a network slice that will serve a particular UE.

Policy management components can include charging function (CHF) and policy control function (PCF) (e.g., PCF 335). CHF allows charging services to be offered to authorized network functions. Converged online and offline charging can be supported. PCF allows for policy control functions and the related 5G signaling interfaces to be supported.

Subscriber management components can include unified data management (UDM) (e.g., UDM 336) and authentication server function (AUSF) (e.g., AUSF 337). UDM can allow for generation of authentication vectors, user identification handling, NF registration management, and retrieval of UE individual subscription data for slice selection. AUSF performs authentication with UE.

Packet control components can include access and mobility management function (AMF) (e.g., AMF 334) and session management function (SMF) (e.g., SMF 333). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF) (e.g., manage UE context and network handovers between base stations) (e.g., UPF 332).

User plane function (UPF) (e.g., UPF 332) can be responsible for packet routing and forwarding, packet inspection, QoS handling, and external PDU sessions for interconnecting with a data network (DN) (e.g., DN 380) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

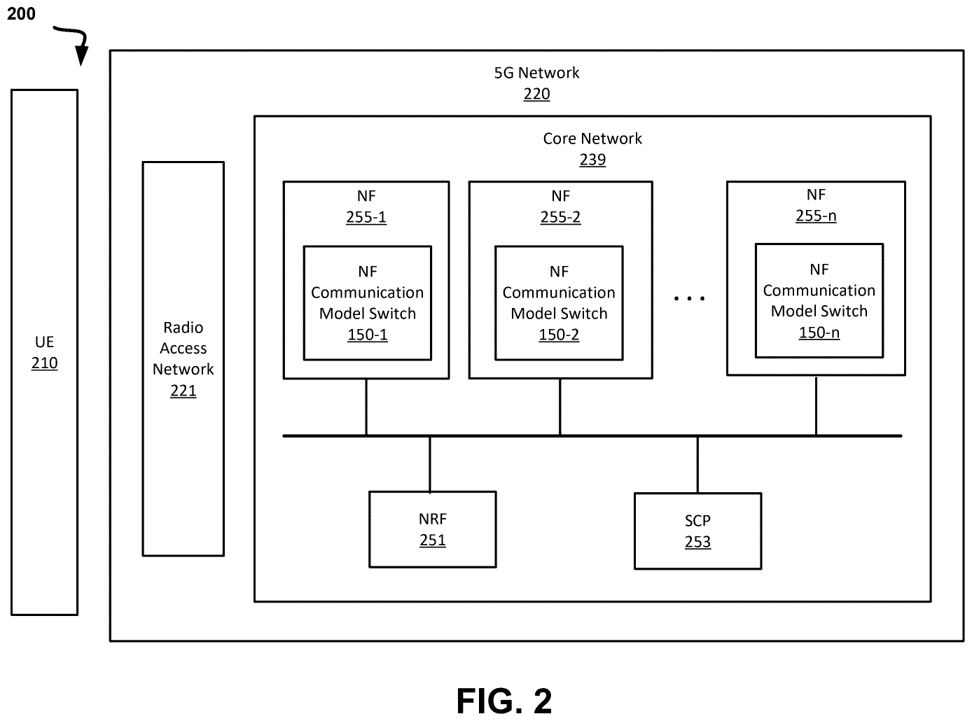

In some embodiments, the 5G core 139 includes a NF communication model switch 150 that implements dynamic switching of NF communication models in a cellular network. In some embodiments, the NF communication model is in multiple components of the 5G core 139. Further details regarding the operations of the NF communication model switch 150 are described below with reference to FIGS. 2-10E.

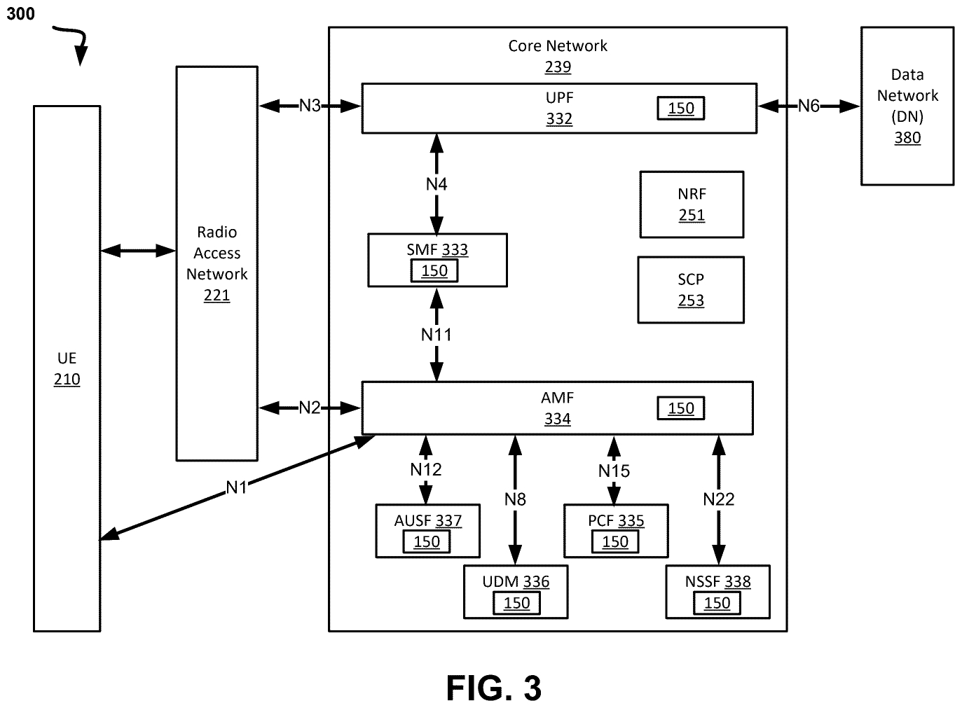

FIG. 2 is a block diagram of example NF communication model switches according to at least one embodiment. Referring to FIG. 2, a 5G network 220 includes a radio access network (RAN) 221 and a core network 239 according to at least one embodiment. The core network 239 includes NRF 251, SCP 253, and multiple NFs 255-1, 255-2, . . . , 255-n, according to at least one embodiment. In at least one embodiment, a NF communication model switch can be implemented in each NF in the core network 239. In at least one embodiment, a NF communication model switch can be implemented in a set of NFs that implements the dynamic switching mechanism in the core network 239. In at least one embodiment, each of NF communication model switches 150-1, 150-2, . . . , 150-n, can independently perform the operations described herein. In at least one embodiment, a combination of any of NF communication model switches 150-1, 150-2, . . . , 150-n, can coordinately perform the operations described herein In at least one embodiment, NF communication model switch 150 described in FIGS. 1 and 3 can be the same to one or more of NF communication model switches 150-1, 150-2, . . . , 150-n.

As shown in FIG. 2, NRF 251, SCP 253, and multiple NFs 255-1, 255-2, . . . , 255-n may communicate with each other over APIs. In some implementations, multiple NFs 255-1, 255-2, . . . , 255-n may communicate with each other over service-based interface (SBI), which allows the decoupling of NFs with precise functionalities with authorization to access each other's service.

FIG. 3 illustrates a block diagram of an example set of NF communication model switches that implement dynamic switching of NF communication models in a cellular network according to at least one embodiment. The set of NFs illustrated in FIG. 3, including UPF 332, SMF 333, AMF 334, PCF 335, UDM 336, AUSF 337, and NSSF 338, is an example of NFs that can implements dynamic switching of NF communication models, and other NFs are also applicable.

Referring to FIGS. 2 and 3, the 5G network 220 may connect user equipment (UE) 210 to the data network (DN) 380, and the DN 380 can include the Internet, a local area network (LAN), a wide area network (WAN), a private data network, a wireless network, a wired network, or a combination of networks. The UE 210 can include an electronic device with wireless connectivity or cellular communication capability, including mobile computing device such as a mobile phone or handheld computing device, and non-mobile computing device. In at least one example, the UE 210 can include a 5G smartphone or a 5G cellular device that connects to the RAN 221 via a wireless connection. The UE 210 can include one of a number of UEs not depicted that are in communication with the RAN 221. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221.

The RAN 221 includes a remote radio unit (RRU) for wirelessly communicating with UE 210. The RRU can include a Radio Unit (RU) and may include one or more radio transceivers for wirelessly communicating with UE 210. The RRU may include circuitry for converting signals sent to and from an antenna of a Base Station into digital signals for transmission over packet networks. The RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210. The RAN 221 can include a new-generation radio access network (NG-RAN) that uses the 5G NR interface. In some embodiments, the distributed unit (DU) and the centralized unit (CU) of the RAN 221 may be co-located with the RRU. In other embodiments, the DU and the RRU may be co-located at a cell site and the centralized unit (CU) may be located within a local data center (LDC). The DU can include a logical node configured to provide functions for the radio link control (RLC) layer, the medium access control (MAC) layer, and the physical layer (PHY) layers. The centralized unit (CU) can be partitioned into a CU user plane portion (CU-UP) and a CU control plane portion (CU-CP). The CU-CP may perform functions related to a control plane, such as connection setup, mobility, and security. The CU-UP may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) can include a logical node configured to provide functions of the control plane part of the RRC and PDCP. The centralized unit for the user plane (CU-UP) can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RRU).

In some cases, the UE 210 may be capable of transmitting signals to and receiving signals from one or more RRUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The network repository function (NRF) 251 may maintain a list of available network functions and provide network function service registration and discovery. The NRF 251 is a network function responsible for the service discovery and can be used by the NFs (referred to as “consumer NF”) for the discovery of other NFs (referred to as “producer NF”) for their services. Each NF of NFs 225-1, 255-2, . . . , 255-n described in FIG. 2 and each NF of UPF 332, SMF 333, AMF 334, PCF 335, UDM 336, AUSF 337, and NSSF 338 described in FIG. 3 may be a consumer NF or a producer NF.

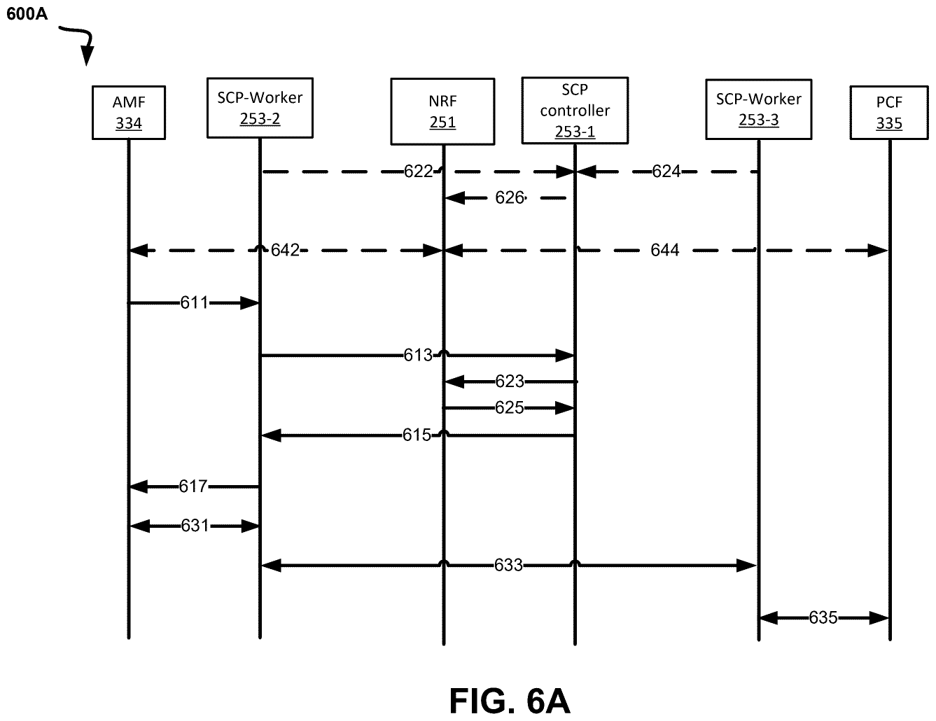

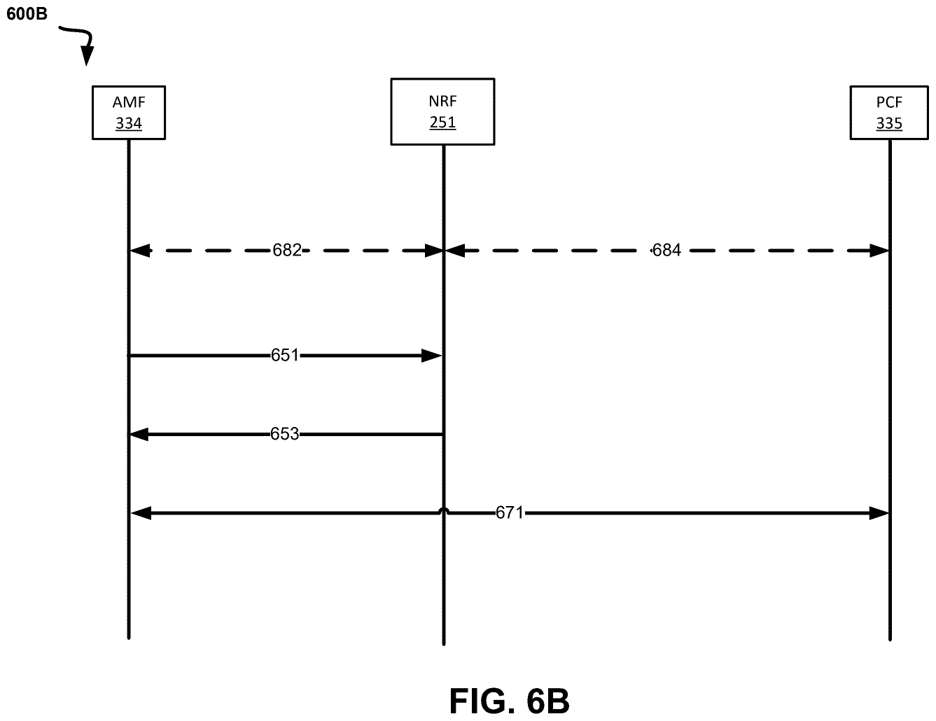

The service communication proxy (SCP) 253 may be a default outbound proxy to NFs or as a router model configured as http2 outbound proxy at each NF in cloud native environments. The SCP 253 may perform a range of important activities including load balancing and load distribution of signaling traffic between different NF instances (or NF services). The SCP 253 may mediate messages between consumer NFs and producer NFs. The SCP 253 may be associated with one or more regional data center(s). In some implementations, the SCP 253 may include SCP controller(s) and SCP worker(s) (e.g., SCP controller 253-1, SCP workers 253-2, 253-3 shown in FIG. 6A). The SCP 253 may learn the topology of the 5G core network from the NRF 251 and provides routing control by creating traffic routing rules based on interactions with the NRF 251. The SCP 253 may enhance security by enabling NF authorization in 5G core network through open authorization framework and client credentials assertion (CCA) procedure that validates consumer's CCA with information in consumer's TLS certificate. The SCP 253 may play part of analytics solution through message feed.

The set of NFs 255-1, 255-2, . . . , 255-n may include primary core network functions and other core network functions. The primary core network functions can include the access and mobility management function (AMF) 334, the session management function (SMF) 333, and the user plane function (UPF) 332. The AMF 334 may act as a single-entry point for a UE connection and perform mobility management, registration management, and connection management between DN 380 and UE 210. The AMF may interface with UE 210 and act as a single-entry point for a UE connection. The AMF 334 may interface with the SMF 333 to track user sessions. The AMF 334 may interface with a network slice selection function (NSSF) 338 to select network slice instances for user equipment. When user equipment is leaving a first coverage area and entering a second coverage area, the AMF 334 may be responsible for coordinating the handoff between the coverage areas whether the coverage areas are associated with the same radio access network or different radio access networks.

The SMF 333 may perform session management, user plane selection, and Internet Protocol (IP) address allocation. The SMF 333 may configure or control the UPF 332. For example, the SMF 333 may control packet forwarding rules used by the UPF 332 and adjust QoS parameters for QoS enforcement of data flows (e.g., limiting available data rates). In some cases, multiple SMF/UPF pairs may be used to simultaneously manage user plane traffic for a particular user device, such as UE 210. For example, a set of SMFs may be associated with UE 210, where each SMF of the set of SMFs corresponds with a network slice. The SMF 333 may control the UPF 332 on a per end user data session basis, in which the SMF 333 may create, update, and remove session information in the UPF 332. Decoupling control signaling in the control plane from user plane traffic in the user plane may allow the UPF 332 to be positioned in close proximity to the edge of a network compared with the AMF 334. As a closer geographic or topographic proximity may reduce the electrical distance, the electrical distance from the UPF 332 to the UE may be less than the electrical distance of the AMF 334 to the UE.

The UPF 332 may perform packet processing including routing and forwarding, quality of service (QoS) handling, and packet data unit (PDU) session management. The UPF 332 may serve as an ingress and egress point for user plane traffic and provide anchored mobility support for user equipment. The UPF 332 may be implemented as a software process or application running within a virtualized infrastructure or a cloud-based compute and storage infrastructure.

The UPF 332 may transfer downlink data received from the data network to user equipment, via the RAN 221 and/or transfer uplink data received from user equipment to the data network via the RAN 221. An uplink can include a radio link though which user equipment transmits data and/or control signals to the RAN 221. A downlink can include a radio link through which the RAN 221 transmits data and/or control signals to the user equipment.

Uplink packets arriving from the RAN 221 may use a general packet radio service (GPRS) tunneling protocol (or GTP) to reach the UPF 332. The GPRS tunneling protocol for the user plane may support multiplexing of traffic from different PDU sessions by tunneling user data over the interface N3 between the RAN 221 and the UPF 332. The UPF 332 may remove the packet headers belonging to the GTP tunnel before forwarding the user plane packets towards the data network. As the UPF 332 may provide connectivity towards other data networks in addition to the data network, the UPF 332 must ensure that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 332 may keep a record of the mapping between the GTP tunnel, the PDU session, and the DNN for the data network to which the user plane packets are directed.

Downlink packets arriving from the data network are mapped onto a specific QoS flow belonging to a specific PDU session before forwarded towards the appropriate RAN 221. A QoS flow may correspond with a stream of data packets that have equal quality of service (QoS). The PDU session may utilize one or more quality of service (QoS) flows to exchange traffic (e.g., data and voice traffic) between the UE 210 and the DN 380. The one or more QoS flows can include the finest granularity of QoS differentiation within the PDU session. The PDU session may belong to a network slice instance through the 5G network 220. To establish user plane connectivity from the UE 210 to the DN 380, the AMF 334 that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Other core network functions may include a policy control function (PCF) 335 for enforcing policy rules for control plane functions, an authentication server function (AUSF) 337 for authenticating user equipment and handling authentication related functionality, a network slice selection function (NSSF) 338 for selecting network slice instances, and an application function (AF) (not shown) for providing application services. Application-level session information may be exchanged between the AF and PCF 335 (e.g., bandwidth requirements for QoS). In some cases, when user equipment requests access to resources, such as establishing a PDU session or a QoS flow, the PCF 335 may dynamically decide if the user equipment should grant the requested access based on a location of the user equipment.

The 5G network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 220. In some cases, the 5G network 220 may support customized policy configuration and enforcement between network slices per service level agreements (SLAs) within the RAN 221. User equipment, such as UE 210, may connect to multiple network slices at the same time (e.g., eight different network slices). In some cases, the 5G network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

The set of NFs may be connected via different interfaces. AMF 334 may be connected to SMF 333 via an N11 interface. AMF 334 may be connected to PCF 335 via an N15 interface. AMF 334 may be connected to UDM 336 via an N8 interface. AMF 334 may be connected to AUSF 337 via an N12 interface. AMF 334 may be connected to NSSF 338 via an N22 interface. The UPF 332 may connect to the SMF 333 via the N4 interface.

The RAN 221 may be connected to the AMF 334, which may allocate temporary unique identifiers, determine tracking areas, and select appropriate policy control functions (PCFs) for user equipment, via an N2 interface. The N2 interface may be used for transferring control plane signaling between the RAN 221 and the AMF 334. The N3 Interface may be used for transferring user data (e.g., user plane traffic) from the RAN 221 to the UPF 332 and may be used for providing low-latency services using edge computing resources. The electrical distance from the UPF 332 (e.g., located at the edge of a network) to user equipment, such as UE 210, may impact the latency and performance services provided to the user equipment. The data may be tunneled across the N3 Interface (e.g., IP routing may be done on the tunnel header IP address instead of using end user IP addresses). This may allow for maintaining a stable IP anchor point even though UE 210 may be moving around a network of cells or moving from one coverage area into another coverage area. The UE 210 may be connected to the AMF 334 via an N1 interface, which may transfer UE information directly to the AMF 334. The UPF 332 may be connected to the data network 380 via an N6 interface. The N6 interface may be used for providing connectivity between the UPF 332 and other external or internal data networks (e.g., to the Internet). The data may not be tunneled across the N6 interface as IP packets may be routed based on end user IP addresses.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The 5G network may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

In FIG. 2, each of the set of NFs 255-1, 255-2, . . . , 255-n may include a NF communication model switch 150-1, 150-2, . . . , 150-n, respectively. In FIG. 3, each of the set of NFs including UPF 332, SMF 333, AMF 334, PCF 335, UDM 336, AUSF 337, and NSSF 338 may include a respective NF communication model switch 150. Each of UPF 332, SMF 333, AMF 334, PCF 335, UDM 336, AUSF 337, and NSSF 338 may be referred to as a type of NF.

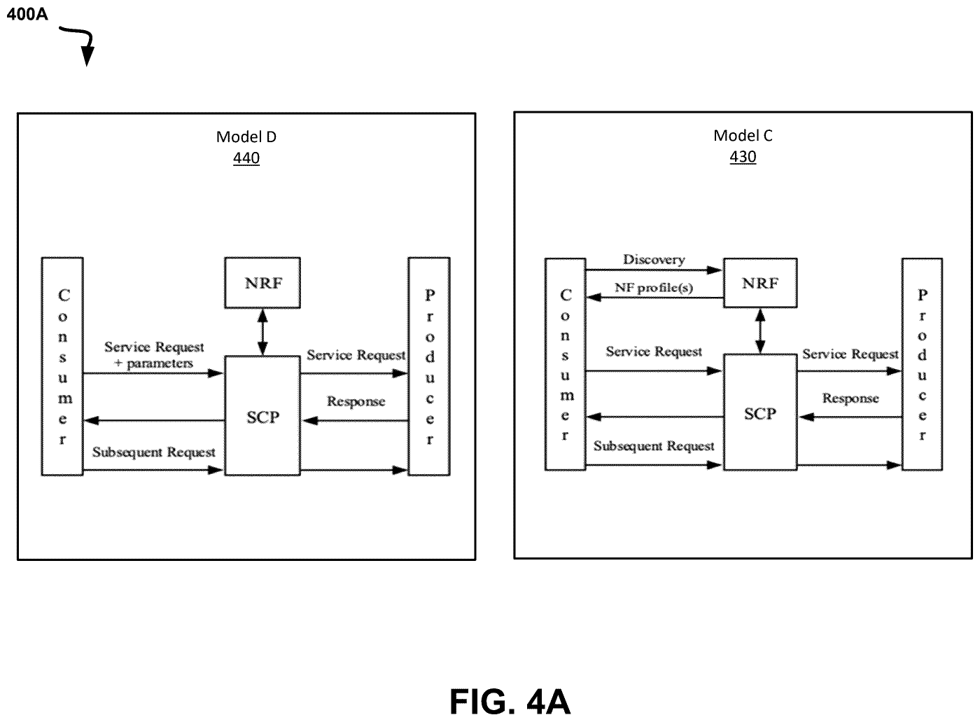

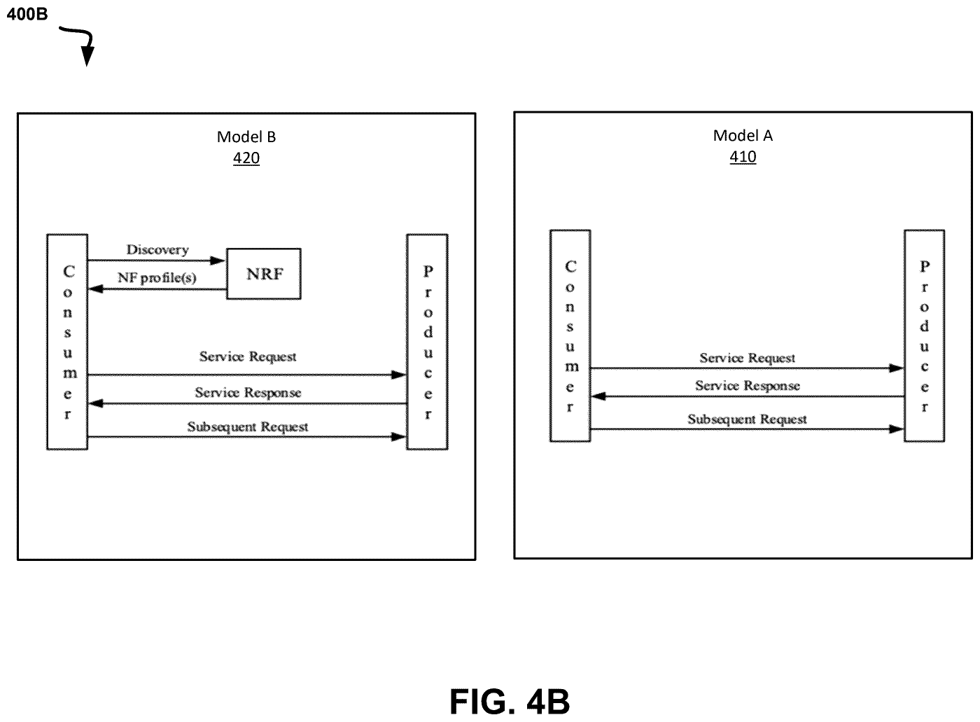

Each NF may be a consumer NF or a producer NF. The consumer NF and the producer NF can communicate in a direct communication model or in an indirect communication model. Within the direct communication model, the consumer NF and the producer NF can communicate directly without proxy, while within the indirect communication model, some operations related to discovery and/or selection are delegated to the SCP. Examples of the indirect communication models are illustrated in FIG. 4A, and examples of the direct communication models are illustrated in FIG. 4B.

Referring to FIG. 4A, model D 440 is an indirect communication model with delegated discovery and selection of NFs to SCP. The SCP performs the discovery of producer NFs via NRF and select the suitable producer NFs based on the parameters received from the consumer NF. The consumer NF sends the service request, via the SCP, to the selected producer NF and receive the response, via the SCP, from the selected producer NF. The SCP thus acts as a routing agent between the consumer NF and the selected producer NF. In some implementations, the SCP performs the discovery of producer NFs via NRF for a specific of NFs. For example, when the consumer NF indicates a specific type NFs (e.g., AMF) in the service request, the SCP performs the discovery of the specific type NFs (e.g., all AMF registered with the SCP and NRF).

Model C 430 is an indirect communication model without delegated discovery of NFs to SCP. The consumer NF communicates directly with NRF for profile registration and discovery of producer NFs. In some implementations, the consumer NF may interact with the NRF multiple times, for example, first for discovery and then for authorization. The consumer NF may receive the profiles of NFs from the NRF and select the suitable producer NFs. The consumer NF may then add the SCP on communication path to the producer NF for some service selections and routing processes. Specifically, the consumer NF may send a service request, via the SCP, to the selected producer NF and receive the response, via the SCP, from the selected producer NF. The SCP thus acts as a routing agent between the consumer NF and the selected producer NF. In some implementations, the SCP may determine whether to override the selected producer NF (e.g., for reasons of load balancing, overload control, operator policy, etc.). In the case that the SCP determines to override the selected producer NF, the SCP may need to fetch another authorization token from the NRF for a newly selected producer NF. In some implementations, the NRF performs the discovery of producer NFs for a specific of NFs. For example, when the consumer NF indicates a specific type NFs (e.g., AMF) in the service request, the NRF performs the discovery of the specific type NFs (e.g., all AMF registered with the NRF).

Referring to FIG. 4B, model B 420 is a direct communication model with interaction with NRF for discovery of NFs. The consumer NF interacts directly with the NRF for discovery of producer NFs, and receive the profiles of NFs from the NRF. Based on the discovery result, the consumer NF selects the suitable producer NF and sends the request to the selected producer NF. The consumer NF may send a service request directly to the selected producer NF and receive the response directly from the selected producer NF. In some implementations, the consumer NF needs to support discovery result caching and selection process. In some implementations, the NRF performs the discovery of producer NFs for a specific of NFs. For example, when the consumer NF indicates a specific type NFs (e.g., AMF) in the service request, the NRF performs the discovery of the specific type NFs (e.g., all AMF registered with the NRF).

Model A 410 is a direct communication model without NRF nor SCP. The consumer NF is statically configured with NF profiles of the producer NF(s). The consumer NF may select the producer NF and directly communicate with the producer NF. Specifically, the consumer NF may send a service request directly to the selected producer NF and receive the response directly from the selected producer NF.

Using FIGS. 2 and 3 as examples for illustration, the consumer NF (e.g., NF 255-1, or AMF 334) runs in the indirect communication model (e.g., model D 440, or model C 430). While consumer NF running in the indirect communication model, the NF communication model switch 150 in the consumer NF may receive a message from SCP 253 indicating a failure of SCP 253 (referred to as “SCP failure message”). In some implementations, SCP 253 may represent multiple SCPs, such as SCP 253-1, SCP 253-2, . . . . SCP 253-n. The failure of SCP 253 may involve configuration issue, infrastructure issue, or deployment issue. For example, the SCP failure message may be a message of geo redundant (GR) SCP failover or GR SCP throwing 5XX error. For example, upon getting a 4xx response from the SCP 253, the NF communication model switch 150 in the consumer NF may reselect a geo redundant SCP, and if all SCPs have been tried and error persists, the communication model switch 150 in the consumer NF may switch back to direct communication model. In another example, upon getting a 5xx response from the SCP 253, the NF communication model switch 150 in the consumer NF may reselect a SCP, and if all SCPs have been tried and error persists, the communication model switch 150 in the consumer NF may switch back to direct communication model.

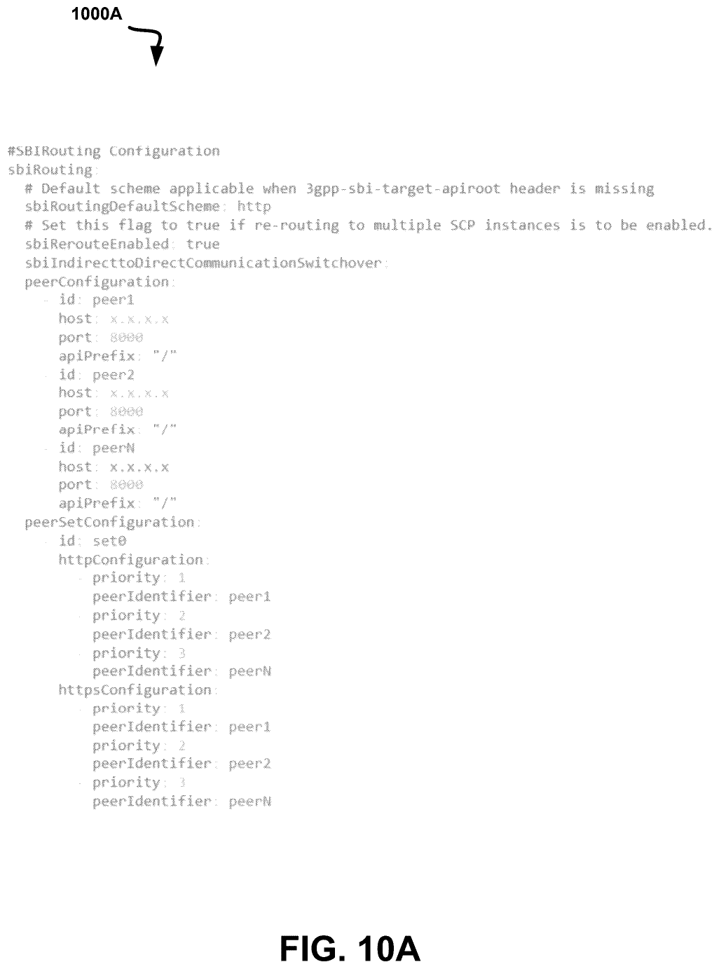

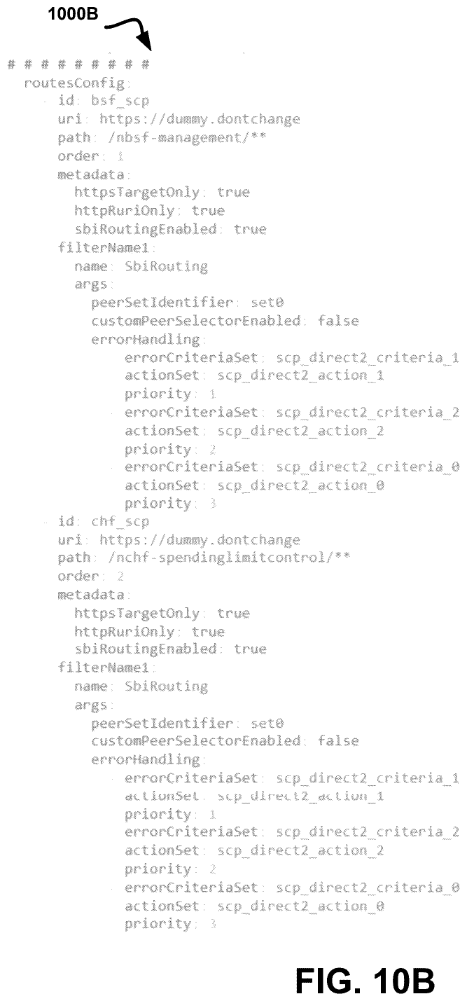

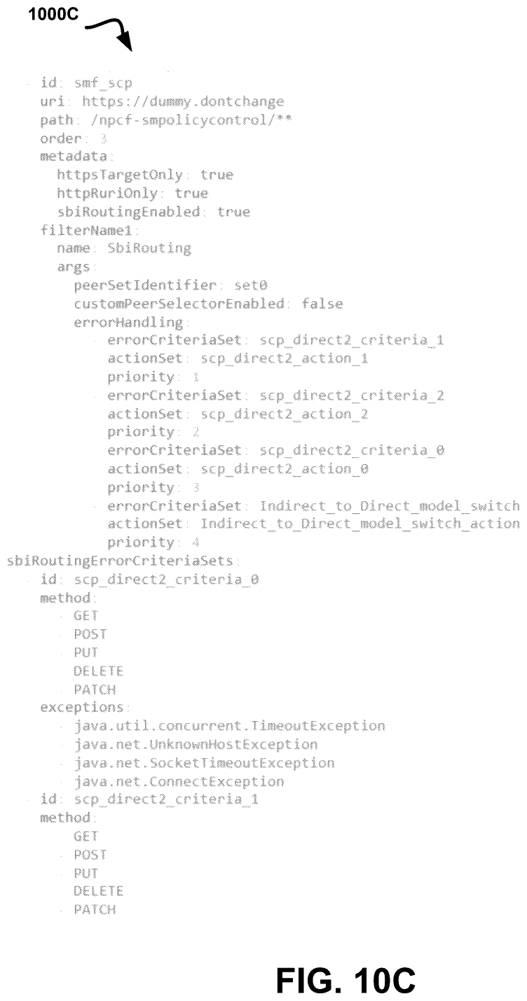

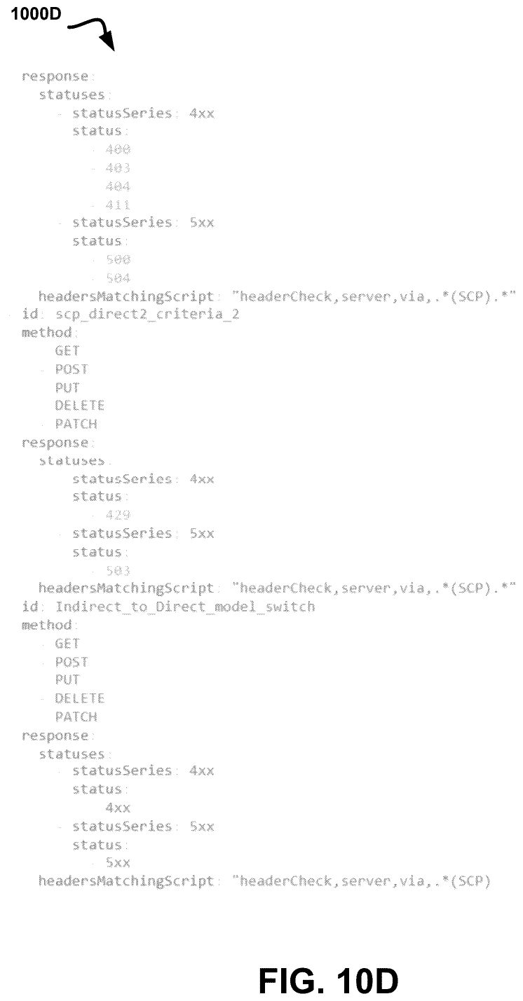

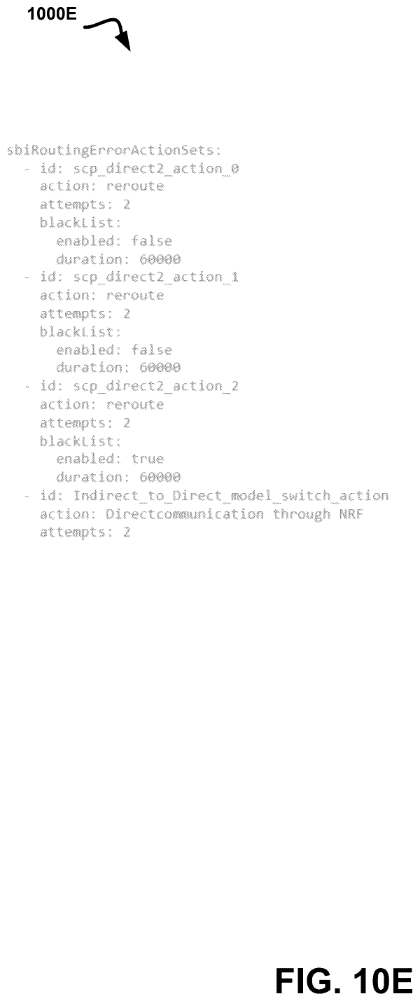

Upon receiving the SCP failure message, the NF communication model switch 150 in the consumer NF may switch from running in the indirect communication model to running in the direct communication model. To switch, the NF communication model switch 150 may modify a configuration setting in the consumer NF to disable the indirect communication model (e.g., model D 440, or model C 430) and enable the direct communication model (e.g., model B 420, or model A 410). The consumer NF may have a configuration profile that include configuration file of each model (e.g., model D 440, model C 430, model B 420, model A 410) and each model may be enabled/disabled. In some implementations, each model (e.g., model D 440, model C 430, model B 420, or model A 410) may be enabled or disabled by a respective flag bit. In some implementations, two bits may be used to store a value (e.g., 00, 01, 10, 11) to indicate the model (e.g., model D 440, model C 430, model B 420, model A 410, respectively) being enabled. Upon modifying a configuration setting, the consumer NF may run in the direct communication model, which does not use SCP. An example of configuration profile for switching from running in the indirect communication model to running in the direct communication model is shown in FIGS. 10A-10E, and the codes illustrated in FIGS. 10A-10E can be read in the order of 1000A-1000E.

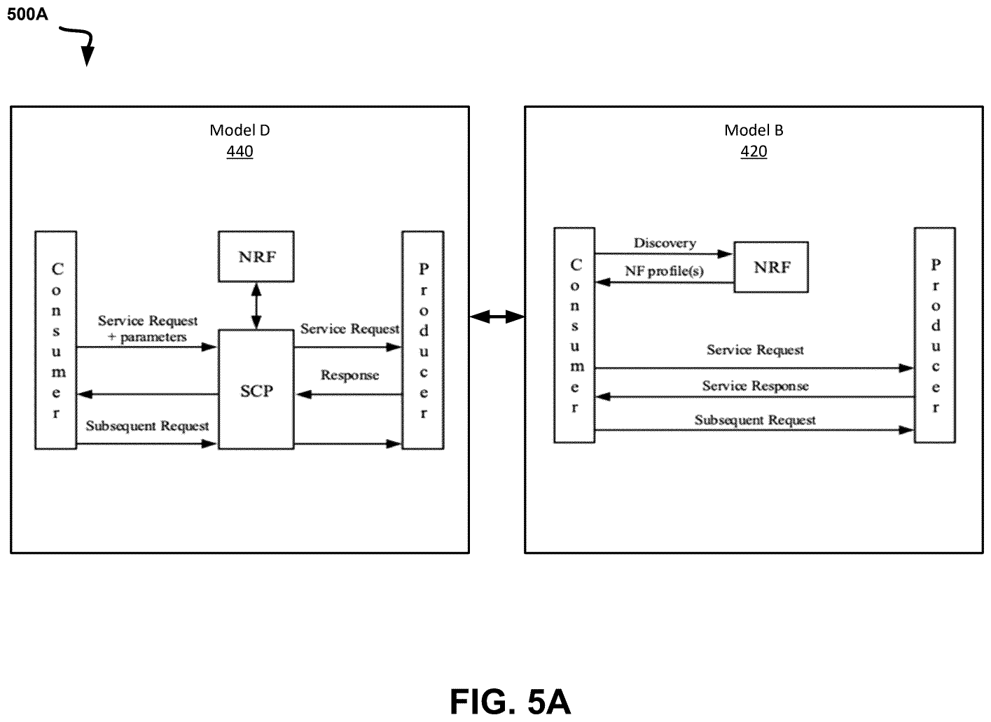

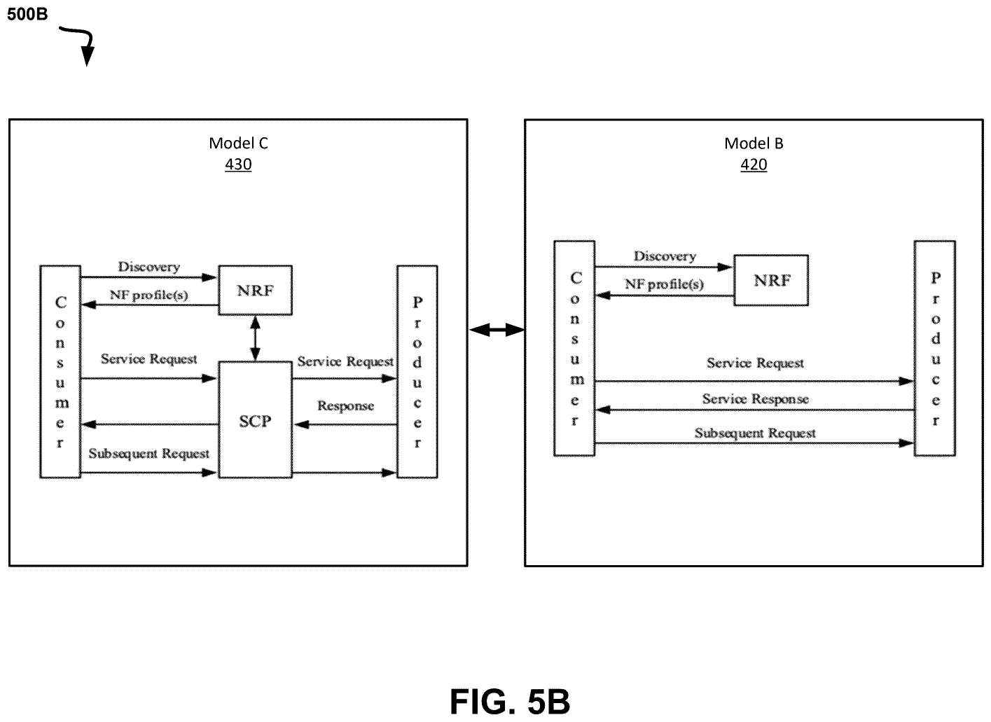

Referring to FIG. 5A, the consumer NF may run in model D 440. Upon receiving the SCP failure message, the NF communication model switch 150 in the consumer NF may modify a configuration setting in the consumer NF to disable model D 440 and enable model B 420. The consumer NF may then run in model B 420.

Referring to FIG. 5B, the consumer NF may run in model C 430. Upon receiving the SCP failure message, the NF communication model switch 150 in the consumer NF may modify a configuration setting in the consumer NF to disable model C 430 and enable model B 420. The consumer NF may then run in model B 420.

After switching from running in the indirect communication model to running in the direct communication model, the NF communication model switch 150 in the consumer NF may monitor the status of SCP. In some implementations, to monitor the status of SCP, the NF communication model switch 150 in the consumer NF may send a dummy signal (or request) to SCP. A dummy signal (or request) may be a sequence of bits that includes a basic (e.g., pre-defined) service request without additional data (e.g., without user data) or a sequence of bits pre-designed for testing the SCP. In some implementations, the SCP may send a response indicating whether the SCP is recovered from the failure. In some implementations, the SCP does not function and thus does not respond to the dummy signal. In some implementations, in response to the dummy signal, the SCP may send a SCP failure message when the SCP is in the failure status. In some implementations, the SCP is recovered from the failure, and the SCP may generate a message indicating that SCP is not in a failure status or a message that indicates a recovery of SCP. For example, the NF communication model switch 150 in the consumer NF may initiate a dummy request to the producer NF through SCP 253 to check whether the SCP 253 is not responding back with any error codes such as 4.x.x. or 5.x.x. The dummy request may be based on the type of interface to include specific parameters/information (e.g., for N7 interface between SMF and PCF, the dummy request may be for creating a n7 session for a test UE).

When receiving a SCP failure message or no message, the NF communication model switch 150 in the consumer NF will do nothing such that the consumer NF continues running in the direct communication model. When receiving a message from SCP that indicates a recovery of SCP or a message indicating that SCP is not in a failure status, the NF communication model switch 150 in the consumer NF may switch back from running in the direct communication model to running in the indirect communication model such that the SCP will be used. For example, when the NF communication model switch 150 in the consumer NF receives a response (e.g., 2xx response) that indicates a successful communication through SCP, the NF communication model switch 150 in the consumer NF may switch back to model D. To switch back, the NF communication model switch 150 may modify the configuration setting in the consumer NF to enable the indirect communication model (e.g., model D 440, or model C 430) and disable the direct communication model (e.g., model B 420, or model A 410), similarly as described above. Upon modifying the configuration setting, the consumer NF may run in the indirect communication model, which uses SCP.

Referring to FIG. 5A, after switching, the consumer NF may run in model B 420. Upon receiving a message from SCP that indicates a recovery of SCP, the NF communication model switch 150 in the consumer NF may modify a configuration setting in the consumer NF to enable model D 440 and disable model B 420. The consumer NF may then run in model D 440 again.

Referring to FIG. 5B, after switching, the consumer NF may run in model B 420. Upon receiving a message from SCP that indicates a recovery of SCP, the NF communication model switch 150 in the consumer NF may modify a configuration setting in the consumer NF to enable model C 430 and disable model B 420. The consumer NF may then run in model C 430 again.

FIG. 6A illustrates an example of communication flow in model D for the model switching, and FIG. 6A illustrates an example of communication flow in model B for the model switching. Referring to FIG. 6A, the consumer NF may be AMF 334, and the producer NF may be PCF 335, which is selected from a set of producer NFs (not shown) by the SCP. The SCP may include two components: the SCP controller 253-1 and the SCP workers 253-2, 253-3. The SCP controller 253-1 may learn network topology by subscribing to notifications from the NRF, derive routing policies and transfer them to the SCP workers 253-2, 253-3, and also host the configuration interface for SCP. The SCP workers 253-2, 253-3 may use the routing policies to route the signaling traffic between consumer NF(s) and producer NF(s). In some implementations, the SCP workers 253-2, 253-3 may report 622, 624 the status of the producer NFs to the SCP controller 253-1, and the SCP controller 253-1 may relay 626 the reported status of the producer NFs to the NRF 251.

In some implementations, the NFs (including consumer NFs and producer NFs) may register with NRF 251. For example, the AMF 334 may send register request 642 to NRF 251 and receive register response 642 from NRF 251, and the PCF 335 may send register request 644 to NRF 251 and receive register response 644 from NRF 251.

In some implementations, the consumer NF-AMF 334 may send a discovery request 611 (e.g., the request may specify a type of NF-PCF) to SCP worker 253-2, where the SCP worker 253-2 can relay the discovery request 613 to the SCP controller 253-1, and the SCP controller 253-1 communicates 623 with the NRF 251 for discovery of producer NFs. The NRF 251 may send the discovery result 625 (e.g., profiles of discovered producer NFs-all PCFs registered with NRF 251) to the SCP controller 253-1, where the SCP controller 253-1 generates, based on the discovery result, the discovery response 615 (e.g., including a selection of the producer NF among the discovered producer NFs based on the locality) to the SCP worker 253-2. The SCP worker 253-2 may send the discovery response 617 (e.g., including a selection of the producer NF among the discovered producer NFs) to the AMF 334.

The AMF 334 may send a service request 631 based on the discovery response 617 to the selected producer NF-PCF 335. The service request 631 is routed via the SCP path 633. The PCF 335 may receive the service request 635 and send a service response 635, via the SCP path 633, to the consumer NF-AMF 334. The AMF 334 thus receives the service response 631 from the PCF 335.

Referring to FIG. 6B, the consumer NF may be AMF 334, and the producer NF may be PCF 335, which is selected from a set of producer NFs (not shown) by the consumer NF. In some implementations, the NFs (including consumer NFs and producer NFs) may register with NRF 251. For example, the AMF 334 may send register request 682 to NRF 251 and receive register response 682 from NRF 251, and the PCF 335 may send register request 684 to NRF 251 and receive register response 684 from NRF 251.

In some implementations, the consumer NF-AMF 334 may send a discovery request 651 (e.g., the request may specify a type of NF-PCF) to the NRF 251 for discovery of producer NFs. The NRF 251 may send the discovery result 653 (e.g., profiles of discovered producer NFs-all PCFs registered with NRF 251 with highest priority defined based on the locality) to the AMF 334, where the AMF 334 may select, based on the discovery result, the producer NF among the discovered producer NFs. The AMF 334 may send a service request 671 directly to the selected producer NF-PCF 335. The PCF 335 may send a service response 671 directly to the consumer NF-AMF 334.

In some implementations, a system (e.g., system 100 in FIG. 1, system 200 in FIG. 2, or system 300 in FIG. 3) may include a computing system to facilitate a cellular network (e.g., the cellular network 120 in FIG. 1, or 5G network in FIGS. 2 and 3), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, system 200 in FIG. 2, or system 300 in FIG. 3) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to an NF communication model switch (e.g., the NF communication model switch 150 of FIGS. 1-3).

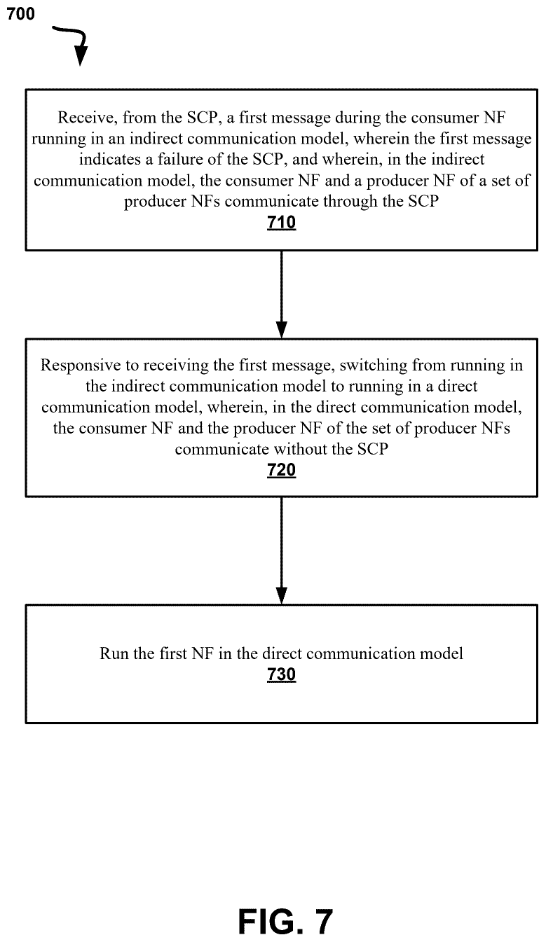

FIGS. 7-9 are flow diagrams of methods 700, 800, and 900 of dynamic switching of NF communication models in a cellular network according to at least one embodiment. The methods 700, 800, and 900 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 700, 800, and 900 are performed by the system 100 of FIG. 1. In one embodiment, the methods 700, 800, and 900 are performed by the NF communication model switch 150 of FIGS. 1-3.

Referring to FIG. 7, at operation 710, the processing logic in the consumer NF (e.g., the first NF) may receiving, from the SCP (e.g., SCP 253), a first message during the consumer NF running in an indirect communication model, wherein the first message indicates a failure of the SCP, and wherein, in the indirect communication model, the consumer NF and a producer NF of a set of producer NFs (e.g., a second NF of a set of second NFs) communicate through the SCP.

In some implementations, in the indirect communication model, the SCP communicates with a network repository function (NRF) for discovery of the set of producer NFs, and the SCP selects the producer NF from the set of producer NFs. In some implementations, the indirect communication model is model D 440. In some implementations, the processing logic may run the consumer NF in the indirect communication model as shown in FIG. 6A.

In some implementations, in the indirect communication model, the consumer NF communicates with a network repository function (NRF) for discovery of the set of producer NFs, and the first NF selects the producer NF from the set of producer NFs. In some implementations, the indirect communication model is model C 430.

At operation 720, responsive to receiving the first message, the processing logic in the consumer NF may switch from running in the indirect communication model to running in a direct communication model, wherein, in the direct communication model, the consumer NF and the producer NF of the set of producer NFs communicate without the SCP. In some implementations, the processing logic may modify a configuration setting in the first NF to switch from running in the indirect communication model to running in a direct communication model.

At operation 730, the processing logic in the consumer NF may run the consumer NF in the direct communication model. In some implementations, in the direct communication model, the consumer NF communicates with a network repository function (NRF) for discovery of the set of producer NFs, and the consumer NF selects the producer NF from the set of producer NFs. In some implementations, the direct communication model is model B 420. In some implementations, the processing logic may run the consumer NF in the direct communication model as shown in FIG. 6B.

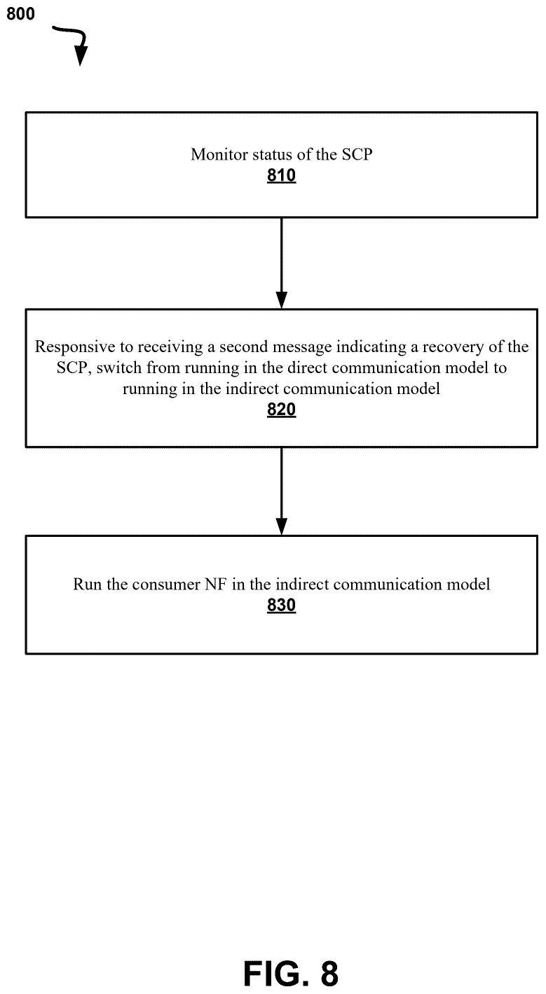

Referring to FIG. 8, at operation 810, the processing logic in the consumer NF may monitor the status of the SCP. In some implementations, to monitor the status of the SCP, the processing logic may send a dummy signal to the SCP periodically and receive, from the SCP, a response of the dummy signal, indicating whether the SCP is recovered from the failure. For example, the response of the dummy signal may include a second message indicating a recovery of the SCP from the failure.

At operation 820, responsive to receiving a second message indicating a recovery of the SCP, the processing logic in the consumer NF may switch from running in the direct communication model to running in the indirect communication model. In some implementations, the processing logic may modify a configuration setting in the first NF to switch from running in the direct communication model to running in the indirect communication model.

At operation 830, the processing logic in the consumer NF may run the consumer NF in the indirect communication model. In some implementations, in the indirect communication model, the SCP communicates with a network repository function (NRF) for discovery of the set of producer NFs, and the SCP selects the producer NF from the set of producer NFs. In some implementations, the indirect communication model is model D 440. In some implementations, the processing logic may run the consumer NF in the indirect communication model as shown in FIG. 6A.

In some implementations, in the indirect communication model, the consumer NF communicates with a network repository function (NRF) for discovery of the set of producer NFs, and the first NF selects the producer NF from the set of producer NFs. In some implementations, the indirect communication model is model C 430.

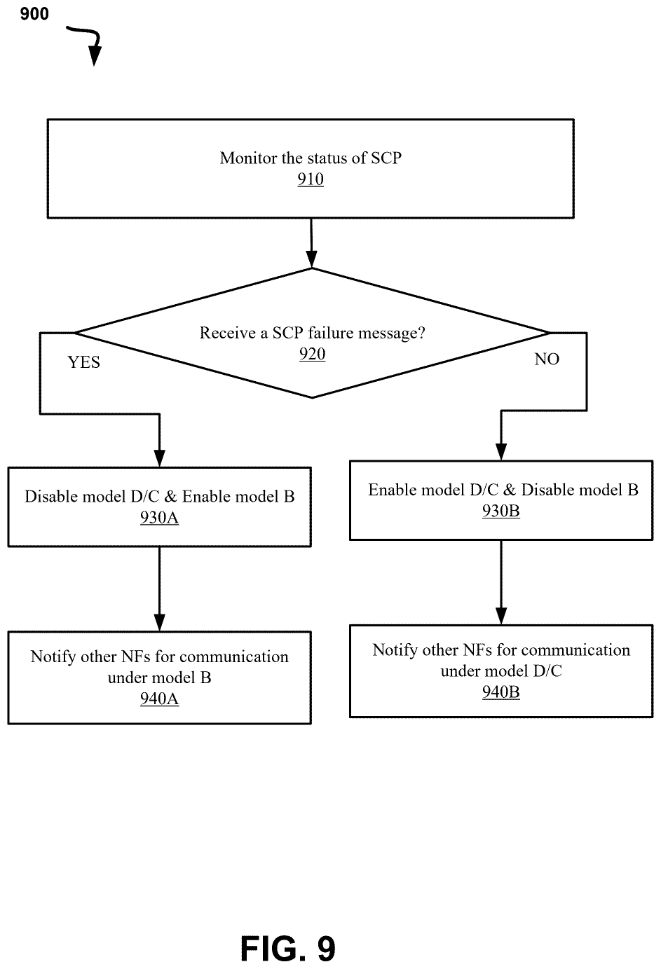

Referring to FIG. 9, at operation 910, the processing logic in a first NF may monitor the status of the SCP, which may be similar to or same as the operation 810.

At operation 920, the processing logic in the first NF may determine whether a SCP failure message is received. In some implementations, the processing logic in the first NF may receive a SCP failure message during the first NF running in the indirect communication model (e.g., model D 440 or model C 430) and thus determine that a SCP failure message is received. In some implementations, the processing logic in the first NF may receive a normal SCP message during the first NF running in the indirect communication model (e.g., model D 440 or model C 430) and thus determine that a SCP failure message is not received. In some implementations, the processing logic in the first NF may receive a SCP failure message during the first NF running in the direct communication model (e.g., model B 420) and thus determine that a SCP failure message is received. In some implementations, the processing logic in the first NF may receive a SCP recovery message during the first NF running in the direct communication model (e.g., model B 420) and thus determine that a SCP failure message is not received.

At operation 930A, responsive to determining that a SCP failure message is received, the processing logic in the first NF may modify the configuration setting by disabling the indirect communication model (e.g., model D 440 or model C 430) and enabling the direct communication model (e.g., model B 420), which may be similar to or same as the operation 720.

At operation 940A, the processing logic in the first NF may notify other NFs (e.g., a set of second NFs) to run in the same direct communication model (e.g., model B 420). These other NFs may be NFs that are registered with the SCP. As such, the processing logic in the first NF can be considered as broadcasting the SCP failure message to all NFs that are using the service of the SCP.

At operation 930B, responsive to determining that a SCP failure message is not received, the processing logic in the first NF may keep or modify the configuration setting by enabling the indirect communication model (e.g., model D 440 or model C 430) and disabling the direct communication model (e.g., model B 420). Keeping the configuration setting means do nothing, while modifying the configuration setting may be similar to or same as the operation 820.

At operation 940B, the processing logic in the first NF may notify other NFs (e.g., a set of second NFs) to run in the same indirect communication model (e.g., model D 440 or model C 430). These other NFs may be NFs that are registered with the SCP. As such, the processing logic in the first NF can be considered as broadcasting the message that the SCP works as normal to all NFs that are using the service of the SCP.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of dynamic switching of network function (NF) communication models in a cellular network, the method comprising:
receiving, by a first NF, from a service communication proxy (SCP), a first message during the first NF running in an indirect communication model, wherein the first message indicates a failure of the SCP, and wherein, in the indirect communication model, the first NF and a second NF of a set of second NFs communicate through the SCP;
responsive to receiving the first message, switching, by the first NF, from running in the indirect communication model to running in a direct communication model, wherein, in the direct communication model, the first NF and the second NF of the set of second NFs communicate without the SCP; and
running the first NF in the direct communication model.

2. The method of claim 1, wherein switching from running in the indirect communication model to running in the direct communication model further comprises:
modifying a configuration setting in the first NF.

3. The method of claim 1, wherein, in the indirect communication model, the SCP communicates with a network repository function (NRF) for discovery of the set of second NFs, and the SCP selects the second NF from the set of second NFs.

4. The method of claim 1, wherein, in the indirect communication model, the first NF communicates with a network repository function (NRF) for discovery of the set of second NFs, and the first NF selects the second NF from the set of second NFs.

5. The method of claim 1, wherein, in the direct communication model, the first NF communicates with a network repository function (NRF) for discovery of the set of second NFs, and the first NF selects the second NF from the set of second NFs.

6. The method of claim 1, further comprising:
monitoring a status of the SCP;
responsive to receiving a second message indicating a recovery of the SCP, switching, by the first NF, from running in the direct communication model to running in the indirect communication model; and
running the first NF in the indirect communication model.

7. The method of claim 6, wherein monitoring the status of the SCP further comprise:
sending a dummy signal to the SCP periodically; and
receiving, from the SCP, a response indicating whether the SCP is recovered from the failure.

8. The method of claim 6, wherein switching from running in the direct communication model to running in the indirect communication model further comprises:
modifying a configuration setting in the first NF.

9. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
receiving, by a first network function (NF), from a service communication proxy (SCP), a first message during the first NF running in an indirect communication model, wherein the first message indicates a failure of the SCP, and wherein, in the indirect communication model, the first NF and a second NF of a set of second NFs communicate through the SCP;
responsive to receiving the first message, switching, by the first NF, from running in the indirect communication model to running in a direct communication model, wherein, in the direct communication model, the first NF and the second NF of the set of second NFs communicate without the SCP; and
running the first NF in the direct communication model.

10. The computing system of claim 9, wherein switching from running in the indirect communication model to running in the direct communication model further comprises:
modifying a configuration setting in the first NF.

11. The computing system of claim 9, wherein, in the indirect communication model, the SCP communicates with a network repository function (NRF) for discovery of the set of second NFs, and the SCP selects the second NF from the set of second NFs.

12. The computing system of claim 9, wherein, in the indirect communication model, the first NF communicates with a network repository function (NRF) for discovery of the set of second NFs, and the first NF selects the second NF from the set of second NFs.

13. The computing system of claim 9, wherein, in the direct communication model, the first NF communicates with a network repository function (NRF) for discovery of the set of second NFs, and the first NF selects the second NF from the set of second NFs.

14. The computing system of claim 9, wherein the operations further comprise:
monitoring a status of the SCP;
responsive to receiving a second message indicating a recovery of the SCP, switching, by the first NF, from running in the direct communication model to running in the indirect communication model; and
running the first NF in the indirect communication model.

15. The computing system of claim 14, wherein monitoring the status of the SCP further comprise:
sending a dummy signal to the SCP periodically; and
receiving, from the SCP, a response indicating whether the SCP is recovered from the failure.

16. The computing system of claim 14, wherein switching from running in the direct communication model to running in the indirect communication model further comprises:
modifying a configuration setting in the first NF.

17. One or more non-transitory, computer-readable storage media having computer-readable instructions thereon which, when executed by one or more processing devices, cause the one or more processing devices to perform operations comprising:
receiving, by a first NF, from a service communication proxy (SCP), a first message during the first NF running in an indirect communication model, wherein the first message indicates a failure of the SCP, and wherein, in the indirect communication model, the first NF and a second NF of a set of second NFs communicate through the SCP;
responsive to receiving the first message, switching, by the first NF, from running in the indirect communication model to running in a direct communication model, wherein, in the direct communication model, the first NF and the second NF of the set of second NFs communicate without the SCP; and
running the first NF in the direct communication model.

18. The one or more non-transitory, computer-readable storage media of claim 17, wherein switching from running in the indirect communication model to running in the direct communication model further comprises:
modifying a configuration setting in the first NF.

19. The one or more non-transitory, computer-readable storage media of claim 17, wherein, in the indirect communication model, the SCP communicates with a network repository function (NRF) for discovery of the set of second NFs, and the SCP selects the second NF from the set of second NFs.

20. The one or more non-transitory, computer-readable storage media of claim 17, wherein, in the direct communication model, the first NF communicates with a network repository function (NRF) for discovery of the set of second NFs, and the first NF selects the second NF from the set of second NFs.
